(19) United States
(12) Patent Application Publication
(10) Pub. No.: US 2009/0100602 A1
(43) Pub. Date: Apr. 23, 2009

(54) Self-ventilating self-cooling cushion apparatus

(76) Inventor: Mario M. Rathie, Belmont, MA (US)

Correspondence Address: Lawson & Persson, P.C., P.O. Box 712, Laconia, NH, 03247-0712, US

(21) Appl. No.: 12/316,714

(22) Filed: Dec. 16, 2008

Related U.S. Application Data
(63) Continuation-in-part of application No. 11/521,970, filed on Sep. 15, 2006.
Application No. 11/521,970 is a continuation of application No. PCT/US2005/008510, filed on Mar. 15, 2005.
(60) Provisional application No. 60/553,793, filed on Mar. 16, 2004.

(51) Int. Cl. A47C 20/00; A47G 9/02; A47D 7/00; B68G 5/02

(52) U.S. Cl. 5/640; 5/652.1; 5/490; 5/655; 5/655.9

(57) ABSTRACT

A self-ventilating and self-cooling cushion including a core formed of a monolithic block of a reticulated foam material having a porosity of between about five pores per linear inch and twenty-five pores per linear inch, and cover surrounding the core. The cover is formed from a material having a plurality of openings therethrough and each of the plurality of openings is dimensioned to allow air to flow freely by natural convection through the cover.

### RELATED APPLICATIONS

This application is a Continuation-in-Part of U.S. Non-provisional application Ser. No. 11/521,970, filed Sep. 15, 2006, which is a continuation of PCT International Application No. PCT/US2005/008510, filed Mar. 15, 2005, which claims the benefit of U.S. Provisional Application Ser. No. 60/553,793, filed Mar. 16, 2004, the entirety of all these applications are hereby incorporated herein by reference for the teachings therein.

### FIELD

The present invention is directed to cushion apparatus, such as sleeping pillows, infant mattresses and pet beds and, more particularly, to self-ventilating self-cooling cushion apparatus.

### BACKGROUND

Many factors affect the amount and quality of sleep that a person can attain on a daily basis. Type and quality of pillow as well as climatic conditions at the sleeping space, all affect a person's sleeping experience. Individuals having difficulty sleeping or enjoying a sound, uninterrupted sleep may be experiencing physical discomfort. Such discomfort may arise as body-generated heat accumulates in the pillow or pillows on which the head of the sleeper is resting, as air cannot circulate through and out of the pillow to dissipate the heat. This heat will eventually be radiated to the sleeping environment, pollute and make it more uncomfortable. Sleeper discomfort can be more pronounced in warmer, humid climates.

Statistics indicate that, in response to pillows becoming warm as body-generated heat accumulates in the pillow, sixty percent of sleepers grudgingly flip their pillows over in search of a cool spot. Such activities can lead to a fitful period of sleep.

In prior and current pillows, body-generated heat accumulates in the pillow due to the nature and geometry of the materials used in pillows, which have a tendency to trap and store rather than dissipate heat. As the body of a sleeper contacts the surface of the pillow, body-generated heat is transferred to and stored in the immediate contact area of the pillow, resulting in a local temperature rise, which may cause sleeper discomfort. Traditionally, pillows and other cushions have essentially consisted of plain envelopes filled with various, usually dense, materials including animal and vegetal fillers, and certain plastic foams, all of which are impervious to the free flow of air and thus trap rather than dissipate heat. Thus, the heat that collects in the pillow takes a significant amount of time to radiate to the environment due to a lack of sufficient airflow therethrough.

The lack of airflow through traditional pillows and other cushions can result in problems far greater that sleeper discomfort. Sudden infant death syndrome deaths (SIDS) of babies in their cribs take the lives of thousands of children each year. It has been theorized that SIDS is caused by self-poisoning; i.e. the infants breathing their own exhaled carbon dioxide. The lack of air movement in their cribs and the greater density of carbon dioxide compared to that of oxygenated air could explain the presence of CO₂ stagnating in the immediate vicinity of the infants in amounts that gradually become deadly. This would be particularly true in the case of infants in the prone position, when their face and nose touch the sheet. This theory recently gained additional support by a study, published in the October 2008 issue of Archives of Pediatrics and Adolescent Medicine, which found that simply putting a fan in the sleeping room reduced an infant's risk of SIDS by seventy-two percent.

The prior art discloses many electro-mechanically assisted pillows to dissipate heat, but the prior art does not offer a simple, efficient and economical solution to deal with both the heat-generated discomfort of a sleeper and the problem of a lack of fresh air flowing around the pillow or other cushion.

U.S. Pat. No. 6,770,085 to Munson discloses a heat absorbing pad comprising a pad bladder and thermoelectric cooling unit to remove heat from a person's body part or pillow. The heat absorbing pad uses a liquid medium which first vaporizes by absorbing heat and is then liquefied when the vapor is moved through a cooling unit.

U.S. Pat. No. 6,516,624 to Ichigaya discloses a cooling pillow, a cooling garment and a cooling helmet, all based on the principle of blowing air on a fibrous material which is in the vicinity of the body and contains a sufficient amount of water to promote vaporization of water so that the body can be cooled by absorption of the heat of vaporization thereupon.

U.S. Pat. No. 6,402,775 to Bieberich discloses high-efficiency cooling pads, mattresses, and sleeves which require complex equipment to cool a person through conduction and/or evaporation. Open-cell foam pads define internal air flow passages with various routings. The pad is wetted and a blower circulates air through the air passages to evaporate the water and thus cool the pad. By contacting the cooled structure, the person is cooled through conduction. The Bieberich devices may expose a person's skin to water, thus creating an uncomfortable sleeping environment.

U.S. Pat. No. 5,653,741 to Grant discloses a heating and cooling pad for heating or cooling a human or animal body part. The flexible pad contains thermoelectric modules, which cool one side of the pad. Air, moving through the pad, cools the hot side of the thermoelectric modules.

U.S. Pat. No. 5,344,436 to Fontenot et al. discloses a localized heat transfer device for topically heating or cooling a human or animal body. A heating or cooling liquid is circulated in a sealed flow path between a heating or cooling device and a heating or cooling pad.

U.S. Pat. No. 4,459,468 to Bailey discloses a temperature control fluid circulating system that uses a thermal cooler to control the temperature of a fluid and pump it through a blanket that can be placed on a person or on top of a pillow to control the temperature.

One patent that does address the problem of lack of airflow through a pillow without electro-mechanical assistance is U.S. Pat. No. 7,255,917 to Rochlin et al. This patent discloses a flexible filtering filler material made up of small pieces of open cell reticulated polyurethane foam, which are said to allow for a free transfer of air allowing convection currents to pass therethrough. Unfortunately, the pillow and filler material described in this patent do not achieve their intended purpose. The use of a plurality of small pieces of open cell foam results in the overlapping of the foam with the open pores and a consequent choking of airflow through the pillow. Further, the use of a common cotton or cotton polyester cover over the pillow prevents air from flowing therethrough without the application of an outside force to create a pressure differential; i.e. a user placing his/her head on the pillow to push air out of it, or a user removing his/her head from the pillow to allow air to be drawn back into it.

The prior art discloses systems of an intricate nature, comprising several complex and expensive components, which are costly to procure, operate and maintain. Such electro-mechanical systems are unreliable as a component may fail functionally when least expected, or not be available such as an electric power source. Further, none address the problem of circulating fresh air around the body to the sleeper. Finally, the prior art does not provide an effective solution for dissipating body heat to prevent sleeper discomfort, or an air passage to improve the comfort level of a sleeper by dissipating body-generated heat and to continually circulate fresh air around the sleeper. Therefore, there remains a need in the art for a method to dissipate body generated heat by natural means to prevent sleeper discomfort, provide an air passage, and provide an oxygenated air space.

### SUMMARY

In its most basic form, the present invention is a self-ventilating and self-cooling cushion including a core formed of a monolithic block of a reticulated foam material having an average porosity of between about five and twenty-five pores per linear inch (p.p.i.), and a cover surrounding the core. The cover is formed from a large open-weave material having a plurality of openings therethrough and each of the plurality of openings is dimensioned to allow air to flow unobstructed and freely by natural convection through the core and the cover.

In one embodiment of the cushion, the openings through the cover are disposed and dimensioned such that there are between about five and one hundred openings per square inch. In the preferred cushion, the openings through the cover are disposed and dimensioned such that there are between about fifteen and fifty openings per square inch, and the monolithic block of a reticulated foam material has a porosity of between about five and ten p.p.i.

In an alternative embodiment of the invention, the core includes two cores and the monolithic block of a reticulated foam material includes a first monolithic block of reticulated foam material and a second monolithic block of reticulated foam material, each having a different porosity.

In a preferred embodiment, the cushion is a variable-geometry pillow including a middle module having a top surface and a middle core, a first outer module and a second outer module. The first outer module and second outer module are connected to the middle module, and each includes a top surface and an outer core. A cores-envelope or cores-harness is provided for securing the first outer module and the second outer module to the middle module such that the first outer module and the second outer module are allowed to rotate with respect to the middle module such that the top surface of the first outer module and the top surface of the second outer module contact the top surface of the middle module.

In embodiments of the variable-geometry pillow that have a cores-envelope, the cores-envelope preferably includes a middle compartment dimensioned to surround the middle core and having open ends proximate to the first outer module and the second outer module. A first outer compartment is dimensioned to surround the first outer core, the first outer compartment including one open end proximate to the middle module. A second outer compartment is dimensioned to surround the second outer core, the second outer compartment including one open end proximate to the middle module. The first outer compartment and the second outer compartment are rotatably attached to the middle compartment. The cores-envelope is preferably formed from a single sheet of material and the first outer compartment and the second outer compartment are rotatably attached to the middle compartment by articulation creases in the sheet of material.

In embodiments of the variable-geometry pillow having a cores-envelope, the cover includes two covers. The inner of the two covers is the cores-envelope and the outer of the two covers is the pillowcase. In such embodiments, the pillowcase is dimensioned to accept the cores-envelope therein and includes a middle compartment, a first outer compartment, a second outer compartment, and a top rotatably attached to the first outer compartment, the second outer compartment and the middle compartment.

In embodiments of the variable-geometry pillow utilizing a cores-harness, the cover is a pillowcase dimensioned to allow the first outer module and the second outer module to rotate with respect to the middle module such that the top surface of the first outer module and the top surface of the second outer module contact the top surface of the middle module.

The cores-harness preferably includes two outer sets of straps, a middle set of straps, and a folding set of straps. A first of the two outer sets of straps is disposed about the first outer module, a second of the two outer sets of straps are disposed about the second outer module, and the middle set of straps are disposed about the middle module. The folding set of straps are disposed about the first outer module, the middle module and the second outer module such that the first outer module and the second outer module rotate with respect to the middle module such that the top surface of the first outer module and the top surface of the second outer module contact the top surface of the middle module.

In some embodiments of the invention, the cushion is a fixed-geometry pillow. In one such embodiment, the core of the fixed-geometry pillow is a single core having a first end, a second opposing end, a third elongated side, and a fourth elongated opposing side, defining a thickness. The thickness increases from the third elongated side to a midpoint between the third elongated side and the fourth elongated opposing side and decreases from the midpoint to the fourth elongated opposing side. In another embodiment, the core is a single core having a first portion, a second portion and a middle portion disposed between the first portion and the second portion. In these embodiments, the middle portion has a thickness that is less than a thickness of the first portion and the second portion. In all embodiments of fixed geometry pillows, the cover is a pillowcase dimensioned to surround the single core.

In some embodiments of the invention, the cushion is a pet bed. In such embodiments, the core includes a base portion and a raised portion extending from the base portion, and the cover is dimensioned to surround the base portion and the raised portion of the core.

Finally, in some embodiments of the invention, the cushion is an infant mattress. In such embodiments, the core includes a single core dimensioned in a shape of a substantially rectangular prism having a top and a bottom defining a thickness, a right side and a left side defining a width, and a front side and a back side defining a length; and the cover is dimensioned to cover the top and at least a portion of the right side, the left side, the front side and the back side. In such embodiments, it is preferred that the cover includes a kangaroo pouch attached to the cover over the top surface of the core.

### BRIEF DESCRIPTION OF THE DRAWINGS

The present invention will be further explained with reference to the attached drawings, wherein like structures are referred to by like numerals throughout the several views. The drawings are not necessarily to scale, the emphasis having instead been generally placed upon illustrating the novel concept and principles of the present invention.

FIG. 1A shows one embodiment of the cushion in which the cushion is a pillow and in which the pillow and pillowcase are in a flat configuration, which may be preferred by a back-sleeper.

FIG. 1B shows the pillow and pillowcase of FIG. 1A transitioning from a flat configuration to a folded configuration, or vice versa.

FIG. 1C shows the pillow and pillowcase of FIGS. 1A and 1B in a folded configuration, which may be preferred by a side-sleeper.

FIG. 2A is a three-dimensional close-up view of a portion of the structure of one type of large-cell reticulated foam material used to form the core of the cushion of the present invention.

FIG. 2B is a three-dimensional close-up view of a portion of the structure of another type of large-cell reticulated foam material used to form the core of the cushion of the present invention.

FIG. 2C is a close-up view of a portion of still another type of reticulated foam material used to form the core of the cushion of the present invention

FIG. 3A is a close-up view of one preferred cover material with an open weave structure for use as a cores-envelope and/or pillowcase.

FIG. 3B is a close-up view of another preferred cover material with an open weave structure for use as a cores-envelope and/or pillowcase.

FIG. 3C is a close-up view of still another preferred cover material with an open weave structure for use as a cores-envelope and/or pillowcase.

FIG. 4A is a perspective view of a pillow of the present invention illustrating a module comprising a single block core in a breathable cores-envelope.

FIG. 4B is a perspective view of a pillow of the present invention illustrating a module that includes a core consisting of two pieces of reticulated foam materials in a breathable cores-envelope.

FIG. 4C is a cross-sectional view taken along line C-C of FIG. 4A of a pillow of the present invention illustrating the airflow through a single block core and a breathable core-envelope carrying away body-generated heat.

FIG. 5A shows a breathable cores-envelope of a pillow of the present invention in the flat configuration.

FIG. 5B shows a breathable cores-envelope of a pillow of the present invention transitioning from a flat configuration to a folded configuration, or vice versa.

FIG. 5C shows the introduction of a plurality of cores into the cores-envelope to form a pillow of the present invention.

FIG. 5D shows a cover envelope material cut into a pattern to form the cores-envelope of the embodiments of FIGS. 5A-5C.

FIG. 6A shows a breathable pillowcase for housing the pillow of FIGS. 5A-5C in a flat configuration with a top surface in an open position.

FIG. 6B shows the breathable pillowcase of FIG. 6A in a flat configuration with a top surface in a closed position.

FIG. 7 is a diagrammatic view of one embodiment of a pillow in which a cores-envelope is replaced by a cores-harness.

FIG. 8 shows an alternative embodiment of a cushion of the present invention taking the form of a traditionally shaped pillow.

FIG. 9 shows an alternative embodiment of a cushion of the present invention taking the form of a pillow having varying thickness to accommodate different types of sleepers.

FIG. 10 shows a cushion of the present invention taking the form of a pet bed.

FIG. 11 is a diagrammatic view of one embodiment of the cushion of the present invention taking the form of an infant mattress.

While the above-identified drawings set forth preferred embodiments of the present invention, other embodiments of the present invention are also contemplated, as noted in the discussion. This disclosure presents illustrative embodiments of the present invention by way of representation and not limitation. For example, although a number of drawings show cushions with substantially sharp corners and edges, it is understood that commercial embodiments are likely to include rounded corners and edges. Further, numerous other modifications and embodiments can be devised by those skilled in the art, which fall within the scope and spirit of the principles of the present invention.

### DETAILED DESCRIPTION

The present invention is a self-ventilating and self-cooling cushion including, but not limited to, a pillow and other similar resting structures, an infant mattress, and a pet bed. As described in greater detail below, the cushion of the present invention includes a core formed from one or more monolithic blocks of a large open-cell reticulated foam material and a cover that surrounds the core and is formed from a material that has openings therethrough that are sized to allow air to flow freely by natural convection through the cover.

### Variable-Geometry Pillow

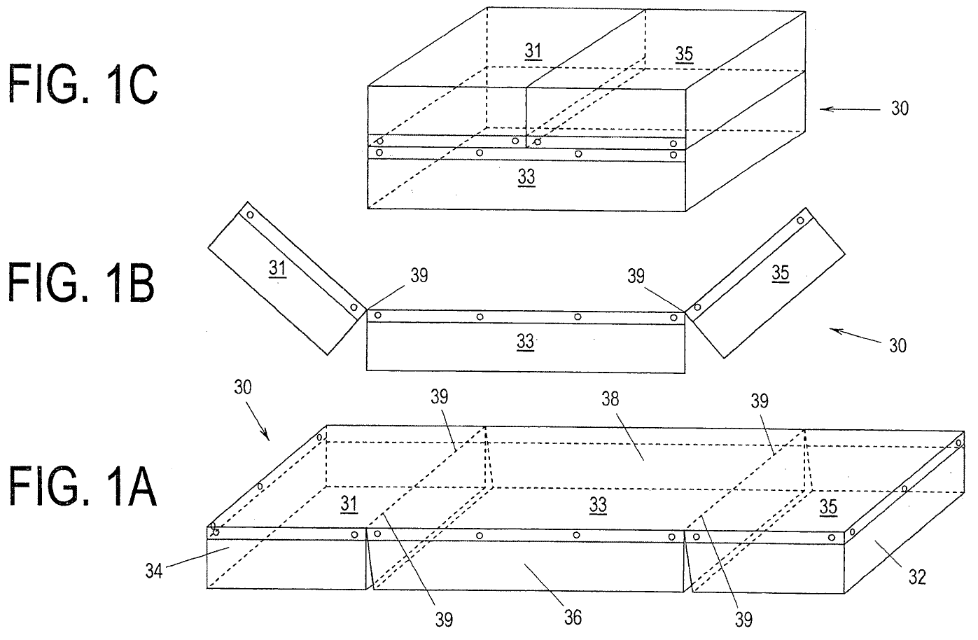

One embodiment of the pillow of the present invention is illustrated generally at 30 in FIGS. 1A-1C. FIGS. 1A-1C show various views of the pillow inside its articulated pillowcase. The pillow 30 may be made from a single block of a reticulated foam material with a large three-dimensional open-cell structure, or from a plurality of blocks of such a material. The open-cell structure permits the pillow to have breathability; i.e. permeability to the free and unobstructed flow of air. All components of the pillow 30, including the core, cores-envelope, and pillowcase, are breathable to dispose of body-generated heat as the heat is being generated and before it is stored in the pillow. The pillow 30 is preferably modular and articulated.

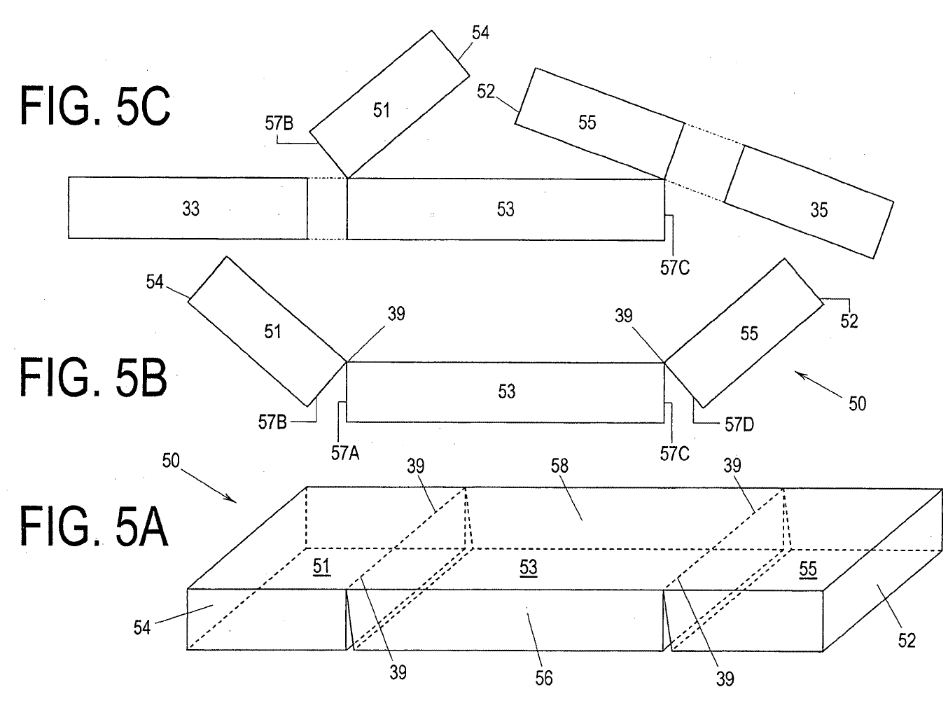

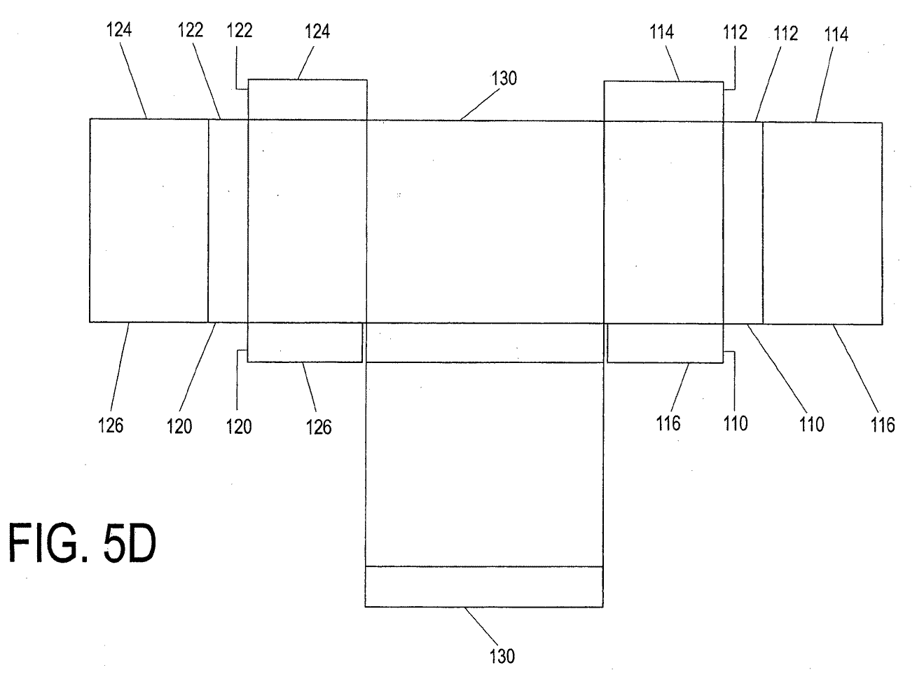

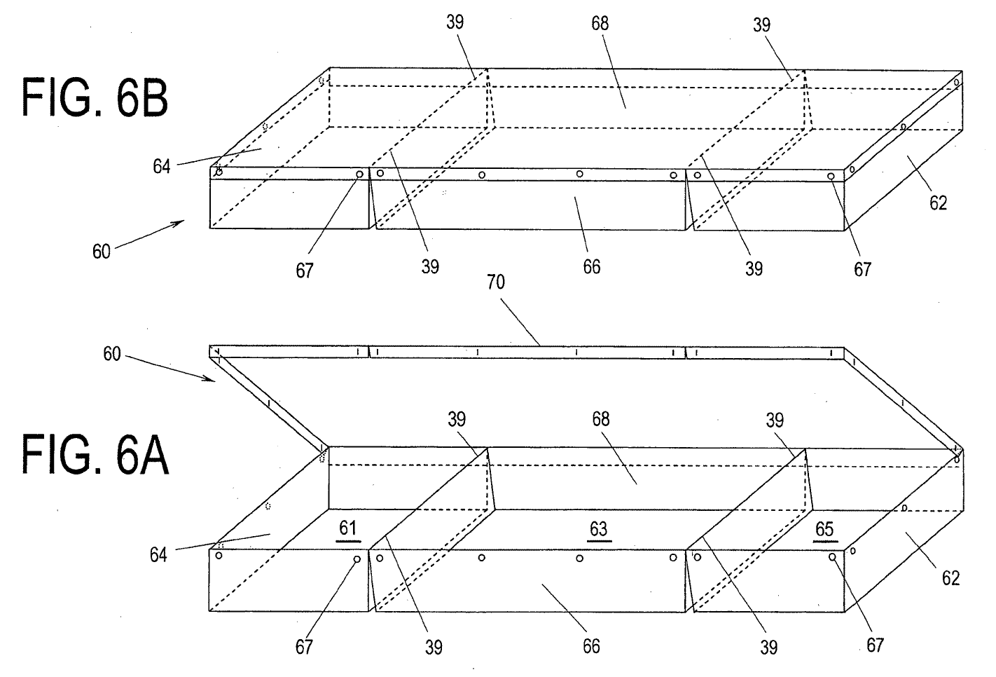

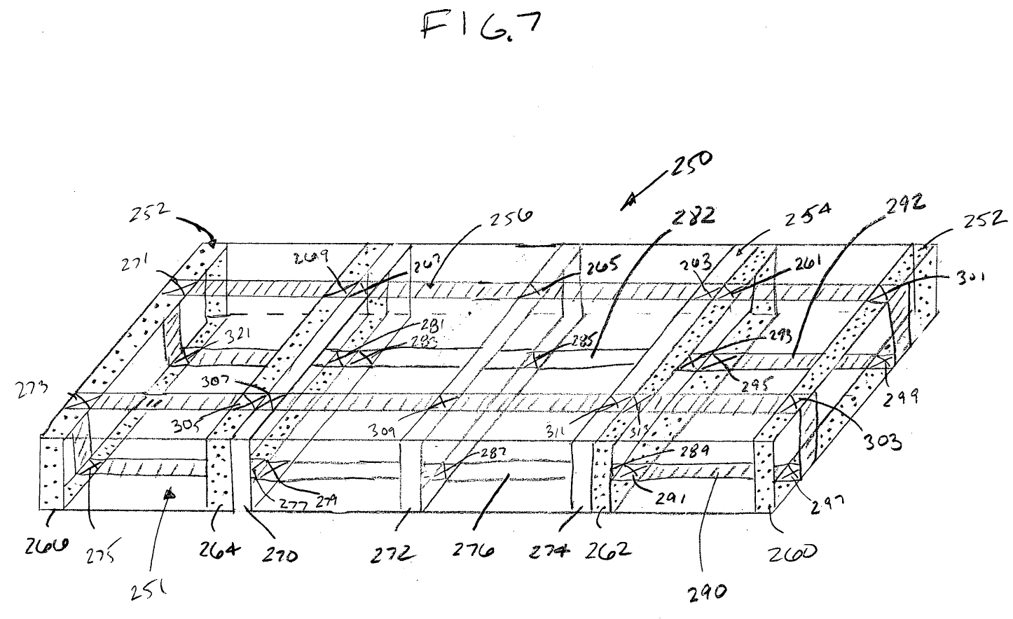

As shown in FIGS. 1A, 1B and 1C, the pillow 30 includes a first perimeter wall 32, a second opposing perimeter wall 34, a third elongated perimeter wall 36, and a fourth elongated opposing perimeter wall 38. The pillow 30 is composed of a plurality of modular monolithic cores 31, 33, 35. The pillow 30 has a middle core 33 with outer cores 31, 35 located alongside the middle core 33. Each of the plurality of cores 31, 33, 35 may be inserted into a cores-envelope 50 (See FIGS. 5A-5C), which may then be inserted into a separate pillowcase 60 compartment (See FIGS. 6A-6B). Alternatively, as described below with reference to FIG. 7, the cores-envelope can be replaced by a cores-harness 250, which will retain the cores 31, 33, 35 in their prescribed positions.

As shown in FIG. 1A, the middle core 33 may be longer than the outer cores 31, 35. The modular cores have similar design and construction characteristics, although having different types of cores within the same pillow 30 is within the spirit and scope of the present invention.

In an embodiment of the present invention, the middle core 33 is about sixteen inches long by eleven inches deep by three inches thick and the outer cores 31, 35 are each about eight inches long by eleven inches deep by three inches thick.

The pillow is articulated so that the plurality of cores 31, 33, 35 can move and pivot about one another. The articulation is provided by the articulation creases 39 along the junctions of the three compartments of the pillowcase 60, which are sized to respectively accept the plurality of cores 31, 33, 35. The pillowcase 60 allows the cores to pivot and rotate about each other along articulation creases 39.

The articulation creases 39 allow the quick repositioning of the outer cores 31, 35 relative to the middle core 33, to convert the pillow 30 from a back-sleeper pillow (FIG. 1A) to a side-sleeper pillow (FIG. 1C), and vice-versa.

In a “flat” configuration shown in FIG. 1A, the thickness of the pillow 30 is designed for stomach and back-sleepers since it allows the head of a user to be positioned at a natural, restful angle. In a “folded” configuration shown in FIG. 1C, the increased thickness of the pillow 30 is such that the head of a side-sleeper would be supported at the proper height so that the spine be properly aligned, thus reducing spinal pressure and increasing sleeper comfort. FIG. 1B shows the assembly of the pillow 30 and the pillowcase 60 transitioning from a flat configuration to a folded configuration, or vice versa.

In one embodiment, the pillow 30 in the flat configuration shown in FIG. 1A has a thickness of about three inches and a length of about thirty-two inches, which is approximately the width of a single bed. In the folded configuration shown in FIG. 1C, the pillow 30 has a thickness of about six inches and a length of about sixteen inches. Those skilled in the art will recognize that the dimensions, including thickness and length, of the present invention may be varied and still be within the spirit and scope of the present invention.

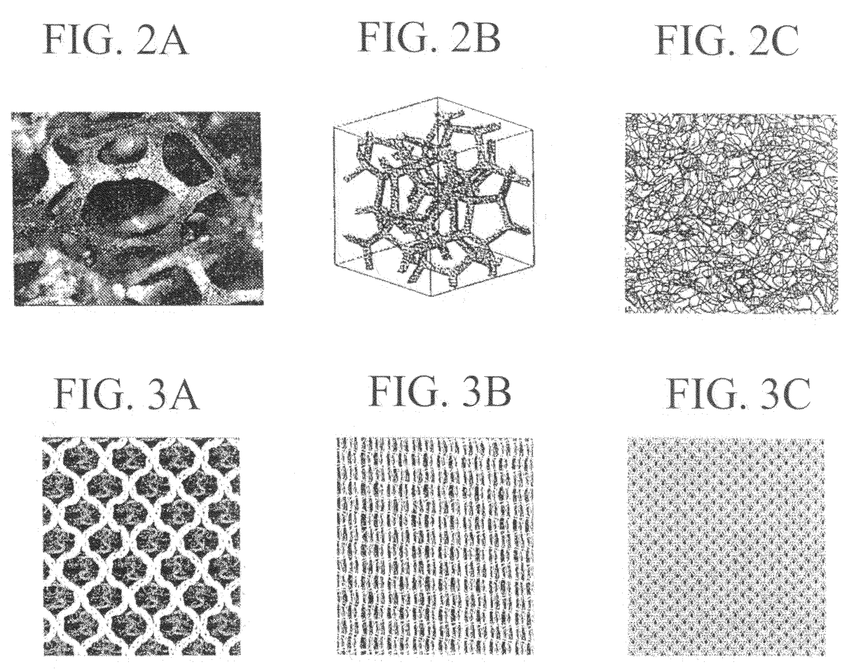

FIG. 2A-2C show close up views of the structure of three types of reticulated foam material used to form the cores 31, 33, 35. As shown in FIGS. 2A-2C, the reticulated foam materials used to form the cores 31, 33, 35 have large three-dimensional interconnected open-cell structures. The larger the open-cell structure of the pillow core, the easier the through-flow of air, the greater the amount of body-generated heat it will carry away, thus reducing sleeper discomfort and keeping the local temperature low. Permeability to the flow of air is an important feature of the open-cell structure.

Reticulated foam is an open-cell foam material in which the window membranes between cells are eliminated, leaving only the skeletal structure of the foam. There are two methods of reticulation that are used to commercial manufacture reticulated foam. The first is controlled flame reticulation. This process involves placing a large mass of foam in a vacuum pressure vessel, evacuating the vessel, filling it with an explosive gas mixture, and igniting the gas such that a controlled flame front passes through the foam. This flame melts the window membranes, leaving the skeletal structure intact. Controlled flame reticulation works with both polyester and polyether polyurethanes and produces a smooth, clean polished cell stand. The second method is chemical quenching, which involves running the mass of foam through a caustic bath of controlled temperature, concentration and duration. The caustic solution attacks and dissolves the window membranes, leaving only the skeletal structure. The foam is then washed, rinsed and dried. Quenching is not effective in polyether polyurethanes, but one benefit of the quenching process is that it produces softer feeling foam; especially in higher porosities.

Reticulated foam may be manufactured from a number of different materials, but is typically manufactured from urethane, polyurethane, or blend of urethanes and other materials. Reticulated foams are commonly used for applications such as humidifier pads, air, water, and dust filters, scrubbing pads, military and medical products. However, reticulate foam has not heretofore been used in monolithic block form as an air-permeable core for a cushion.

The reticulated foam used for the core of the cushion of the present invention has not more than an average of twenty-five p.p.i. (pores per linear inch) and preferably has a porosity of between about five and ten p.p.i. It is noted that the number of pores in reticulated foam material is customarily measured in the industry by p.p.i., which refers to the average number of pores per linear inch and not the number of pores per square inch.

While the porosity of the open-cell structure of the reticulated foam material can vary, this structure and porosity are chosen because their combination permits air to flow freely and dissipate body-generated heat. The porosity of the large open-cell structure of the reticulated foam material facilitates airflow. A material of such an open structure will allow air to flow freely through the pillow to dissipate body-generated heat. A material with a large open-cell structure that is totally permeable to the flow of air in all directions would allow air circulation, facilitate the flushing of and eliminate the pockets of stagnant hot, spent air, and thus reduce the discomfort by eliminating the accumulation of heat.

The open-cell structure of reticulated foam also provides strength to support the weight of the head of a user, reduces the pressure points created by engagement with the surface, and improves blood circulation. The open-cell structure also supports properties such as fire retardancy and resiliency.

The large open-cell structure of the reticulated foam core material of the pillow 30 provides a plurality of channels for the air to flow through unrestricted and carry the heat away. Heat transfer is enhanced by the high volume-to-surface ratio of the pillow. The flow and motion of the air consequently follow the natural laws of heat and mass transfer. Warmer air rises, cooler air falls. Heavier gases will settle below lighter ones. As their motion and flow do not depend on any electro-mechanical assist, this exchange is totally silent and totally mobile with nothing that can break or fail, and will require no maintenance personnel or operating budget.

Due to its open-cell configuration, the present invention dissipates body-generated heat to relieve discomfort that is generally caused by the interaction of the body with the bedding system. As a portion of the body of a sleeper engages a contacting surface of the pillow 30, body-generated heat is stored in the local environment where the body engages the contacting surface. Heat transfer from the contacting surface by conduction, convection and thermal radiation is enhanced by the open-cell structure which provides a plurality of channels for the air to flow through and carry away the heat.

Heat transfers by conduction, convection and thermal radiation. Heat transfer is a function of both temperature and flow of heat. Temperature is one measure of the amount of thermal energy available. Flow of heat is the movement of that thermal energy from place to place. Heat always transfers from a higher temperature body to a lower temperature body. In the absence of a temperature gradient, there will be no heat transfer, and no heat flow. Heat transfer changes the internal energy of both the high temperature body and the low temperature body in accordance with the first law of thermodynamics, that the amount of energy lost (given-up) by the higher temperature body is equal to the amount of energy gained (received) by the lower temperature body. The first law of thermodynamics is the application of the principle of conservation of energy to heat.

In conduction, heat transfers by molecular agitation only, within a material, and without any motion of the material as a whole. As the heat energy flows from the region of high temperature to the region of low temperature, the hotter higher-energy, higher-speed particles agitate and collide internally with the colder lower-energy, lower-speed particles, imparting their energy and raising their temperatures. In the present invention, some heat also dissipates by conduction along the cell nodes.

In convection, heat transfers by the bodily movement of a mass of fluid such as air or water. The fluid moves away from the source of heat, carrying heat energy with it. When heating occurs to a static fluid, there is a local volumetric expansion accompanied by a local corresponding drop in density. Gravity-induced pressure gradients cause the expanded fluid to become buoyant and displaced, transferring heat by motion of the hot fluid.

Thermal radiation is the transfer of heat energy emanating from warm surfaces in the form of electromagnetic waves. Thermal radiation does not require a medium for propagation. Heat transfer by thermal radiation occurs between solid surfaces, even in a vacuum.

Ambient air present in the room will flow freely through any of the faces of the pillow delineated by its perimeter. The open-cell configuration of the present invention offers a high volume-to-surface ratio to the free flowing air, and thus enhances the extraction of any heat from the plurality of cores 31, 33, 35 of the pillow 30, and carries it to the atmosphere. Some heat is also dissipated by conduction along the cell nodes. Discomfort caused to a sleeper by a temperature rise due to body-generated heat is eliminated.

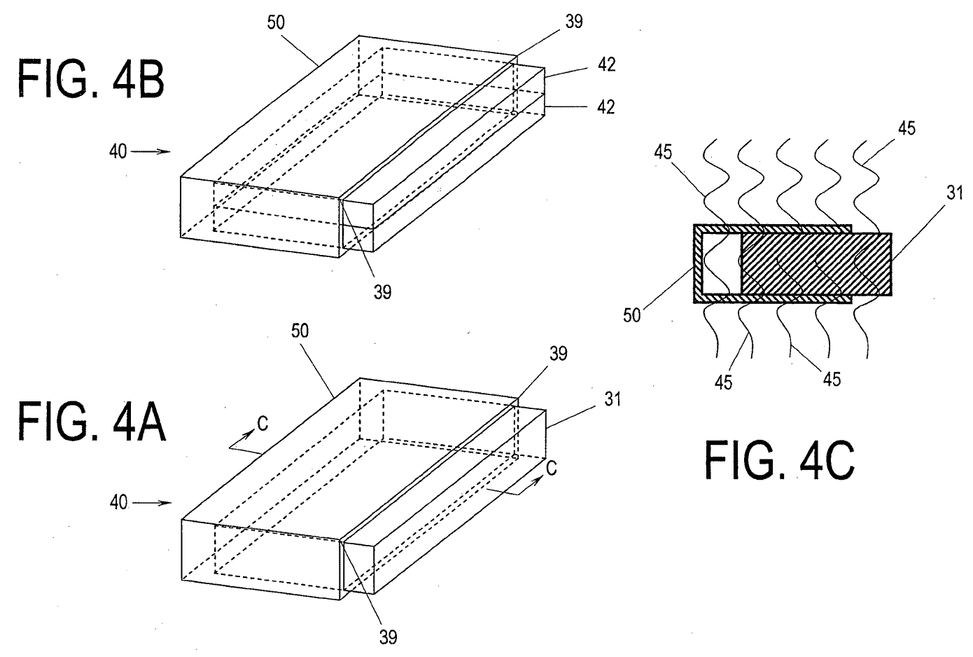

The open-cell configuration and the modular construction of the pillow 30 of the present invention provide a matrix that is easy to clean when necessary. FIGS. 4A, 4B and 4C show a module of the pillow 30. The modules are composed of one of the plurality of cores 31, 33, 35 inserted in a cores-envelope 50. The pillow 30 of the present invention has a plurality of modules. In an embodiment shown in FIGS. 1A-1C, the pillow has three modules. Pillows having one, two, four or more modules are also within the spirit and scope of the present invention. The pillow modules can be soaked in a cleaning solution then rinsed. Because of their open-cell geometry, pillow modules will dry rapidly.

By allowing air to flow through the open-cell structure, the local environments of the pillow 30 and of its user become more oxygenated than those of the prior art which lack the permeability to air flow. As discussed in more detail below, this particular feature may have a useful application in conquering sudden infant death syndrome deaths (SIDS) of babies in their cribs at home, and even in their bassinets at the hospitals' nurseries. By providing a more oxygenated air space, the open-cell configuration can be used to prevent SIDS. The air flowing through the open-cell structure would carry away the exhaled carbon dioxide and bring in a fresh oxygen-rich air for the infant.

The reticulated foam material making up the cores 31, 33, 35 of the pillow 30 will recover from its stresses and strains when a load is removed. Upon receiving the weight of the head of a user, the cores 31, 33, 35 of the pillow 30 of the present invention do not return a force directly proportional to its deflection. Rather, the cores 31, 33, 35 of the pillow 30 relax under the load while providing pressure distribution across the head of the user. The distribution of pressure reduces pressure points, eliminates potential vascular restrictions and improves comfort. After removal of the weight load of the head, the cores 31, 33, 35 return the pillow 30 back to an original unloaded configuration.

As discussed above, since the density and type of the open-cell configuration of the pillow 30 of the present invention control the firmness of the pillow, by changing them, the firmness and softness of the pillow can be varied. Whereas the firmness of the pillow 30 of the present invention can be changed, the large size of the open-cell structure will remain unaltered in order to maintain the free and easy through-flow of air and dissipate the body-generated heat.

As shown in FIG. 4A, some embodiments include a module 40 having a core 31 made up of a single block of reticulated foam within a breathable core-envelope 50. As shown in FIG. 4B, other embodiments include a module 40 having a core made up of a plurality of blocks 42 of reticulated foam material and the breathable cores-envelope 50. It is noted that, although FIG. 4B shows the use of two blocks 42 of the same type of reticulated foam, some embodiments include cores 31 made from different types of reticulated foam. For example, some embodiments may utilize a block of firmer reticulated foam as a base layer and a second block of softer reticulated foam as the contact layer.

Regardless of the type or types of reticulated foam used, the core 31 is always manufactured of discrete monolithic blocks of reticulated foam and not small pieces thereof. By utilizing discrete monolithic blocks of reticulated foam, the open cells of the reticulated foam do not risk being blocked by adjacent small pieces of foam. This allows a free and unobstructed flow of air and of body-generated heat it is carrying away. Further, by using monolithic blocks, the natural structural lay of the reticulation and of the resulting porosity are not disturbed. As illustrated in FIG. 4C, the permeability of the core 31 and the core-envelope 50 allow the airflow 45 to dissipate heat solely by natural convection and without the need for the application of an outside force to create a pressure differential.

### Cores-Envelope

The plurality of cores 31, 33, 35 are assembled in a breathable articulated cores-envelope 50 shown in FIGS. 5A-5C. FIG. 5A shows the breathable cores-envelope 50 of a pillow 30 of the present invention in the flat configuration. The cores-envelope 50 has a plurality of compartments 51, 53, 55 sized to accept the plurality of cores 31, 33, 35.

To maximize the flow of air through the open-cell structure of the plurality of cores 31, 33, 35 of the modules of the pillow 30, the cores-envelope 50 is also breathable and permeable to air. The cores-envelope 50 structure permits the easy, free, continuous and unobstructed flow of air to and through the plurality of cores 31, 33, 35 to dissipate the body-generated heat away from the pillow 30 into the atmosphere.

A cores-envelope that restricts the flow of air in natural convection, such as the linen or other cloth materials used in traditional pillows, could not be used as it would be a barrier to the flowing air and escaping heat. Rather, as shown in FIGS. 3A-3C, the material of the cores-envelope, or other cover, has an open-weave structure with a plurality of openings therethrough that are sized to allow air to flow unobstructed and freely by natural convection therethrough. The material making up the cores-envelope has between five and one hundred openings per square inch. In the preferred embodiment, this material has preferably from about fifteen to fifty openings per square inch.

Those skilled in the art will recognize that breathable cores-envelopes can be made from many materials made from man-made and natural fibers, and be within the spirit and scope of the present invention. However, in all cases, the materials will be air-permeable so as not to restrict the flow of air in natural convection. Additionally, it is noted that the material of the cores-envelope 50, or other cover, is preferably durable, washable, hypoallergenic, cushioning, and environmentally friendly.

The cores-envelope 50 of the present invention includes a first perimeter wall 52, a second opposing perimeter wall 54, a third elongated perimeter wall 56 and a fourth elongated opposing perimeter wall 58. The plurality of compartments 51, 53, 55 of the cores-envelope 50 are articulated to allow them to rotate and pivot about each other as shown in FIG. 5B. FIG. 5B shows the breathable cores-envelope 50 of a pillow 30 transitioning from a flat configuration to a folded configuration, or vice versa.

FIG. 5C shows the introduction of the plurality of cores 31, 33, 35 into the breathable cores-envelope 50 of a pillow 30. As shown in FIG. 5B and FIG. 5C, the middle compartment 53 is open at both ends 57A, 57C so the middle core 33 can be inserted into the middle compartment 53 from either end 57A, 57C. The outer compartment 51 is delineated by a perimeter wall 54 at one end, while its opposite end 57B is open to receive the outer core 31. The outer compartment 55 is delineated by a perimeter wall 52 at one end, while its opposite end 57D is open to receive the outer core 35.

In the flat configuration shown in FIG. 5A, surfaces 57A and 57B are contiguous and adjacent and surfaces 57C and 57D are contiguous and adjacent. At these locations, the outer cores 31 and 35 each engage the middle core 33 to prevent the plurality of cores 31, 33, 35 from moving. As there are no partitions between the plurality of cores 31, 33, 35, the plurality of cores 31, 33, 35 act almost as one long continuous core extending from the perimeter wall 52 of the cores-envelope 50 to the opposing perimeter wall 54 of the cores-envelope 50. The absence of partitions between the plurality of cores 31, 33, 35 further facilitates the flow of air.

FIG. 5D shows a cover material cut into a pattern used to form the cores-envelope of the embodiment of FIGS. 5A-5C. The material used to create cores-envelope 50 may be a single piece or composed of a plurality of pieces connected together. Sewing together the like-numbered segments in FIG. 5D will yield the cores-envelope 50 of the present invention. For example, the two segments or seams 114 are engaged to form a perimeter of the cores-envelope 50. The two segments or seams 110, 112, 116, 120, 122, 124, 126 and 130 are engaged to form a perimeter of the cores-envelope 50. The segments may be engaged by sewing or by mechanical fasteners including, but not limited, to a button, hook-and-loop fastener, snap, zipper or other mechanical fasteners, which operates on contact or pressure to mechanically engage two components.

The articulated design of the cores-envelope 50 permits the quick and easy re-positioning of one or both outer modules, as illustrated at FIG. 1C and FIG. 5C, thus doubling the overall thickness of the pillow, to convert the pillow 30 of the present invention from a back-sleeper pillow to a side-sleeper pillow, and vice-versa. The articulation occurs along creases 39 shown in FIG. 1A and FIG. 5A, which allow movement and rotation.

### Cores-Harness

In the preferred embodiment, the cores-envelope 50 of FIGS. 5A-5B is replaced with a cores-harness 250. The cores-harness 250 includes a plurality of straps which retain the cores 31, 33, 35 in substantially the same arrangement as the cores-envelope 50 of FIGS. 5A-5B. By almost eliminating the entire layer of breathable cover material of the cores-envelope 50, the airflow within the pillow is very markedly improved. In fact, the use of the cores-harness reduces the amount of cover material through which air must flow by approximately seventy five percent.

As shown in FIG. 7, the cores-harness 250 is made up of three sets of straps 252, 254, 256. The outer sets of straps 252, denoted by dotted hatching, are disposed about each outer module of the pillow. The outer sets of straps 252 are made up of outer straps 260 and 262 at one end, and straps 264 and 266 at the other end. These outer straps 260, 262, 264, 266 each run perpendicular to the sidewall 251 of the pillow. The middle set of straps 254, which has no hatching, is made up of five middle straps 270, 272, 274, 276, 282. Middle straps 270, 272, 274 each run perpendicular to the sidewall 251 of the pillow, while middle straps 276, 282 run parallel to the sidewall along the bottom of the middle module of the pillow. The five middle straps 270, 272, 274, 276, 282 making up the middle set of straps 254 are joined together along the bottom of the pillow at joints 279, 283, 285, 287, 289 and 293. The folding set of straps 256, denoted by parallel line hatching, is made up of straps 290, 292. These straps 290, 292 are secured to the outer straps 264 at joints 277 and 281, extend around the left outer module, over the entire top of the pillow, and around the right outer module and are secured to outer strap 262 at joints 291, 295. The folding straps 290, 292 are also secured to all of the other straps along the top of the pillow at joints 271, 273, 305, 307, 269, 267, 265, 309, 263, 261, 311, 313, 303, and 301 and to the outer straps 266, 260 at joints 275, 321, 297 and 299. The folding straps 290, 292 allow the outer modules of the pillow to be rotated upward to rest on the middle module in the same manner as shown in FIG. 5B.

The cores-harness 250 allows the core modules (not shown) to be secured together in a manner that allows the outer modules to be rotated upward over the middle module, while eliminating the need for a separate cores-envelope. This is preferred as it allows for a more free flow of air from module to module and from the cores to the pillowcase.

### Pillowcase

The cores-envelope 50 containing the plurality of cores 31, 33, 35 may be inserted into a pillowcase 60. The pillowcase 60 used in conjunction with the pillow 30 of the present invention is generally illustrated in FIG. 6A, which shows the breathable pillowcase 60 in the flat configuration with a top surface 70 in an open position. FIG. 6B shows the breathable pillowcase 60 in the flat configuration with the top surface 70 in the closed position.

The breathable pillowcase 60 is used to allow room air to enter the pillow 30, flow through the plurality of cores 31, 33, 35 and carry away to the atmosphere the body-generated heat. The pillowcase 60 is manufactured of the same types of cover materials shown in FIGS. 3A-3C and permits the easy, free, continuous and unobstructed flow of air. A pillowcase made of a traditional tightly-woven material would not possess the property of air-permeability required and would be an unacceptable barrier to the free flow of air. The material of the pillowcase has an open-weave structure and has between five and one hundred openings per square inch. In the preferred embodiment, this material has preferably from about fifteen to fifty openings per square inch. Those skilled in the art will recognize the breathable pillowcase can be made of many materials known in the art and be within the spirit and scope of the present invention.

The pillowcase 60 includes a first perimeter wall 62, a second opposing perimeter wall 64, a third elongated perimeter wall 66 and a fourth elongated opposing perimeter wall 68. Within this perimeter, the pillowcase 60 has a plurality of breathable articulated compartments 61, 63, 65, sized to respectively accept the plurality of cores 31, 33, 35 enclosed in the plurality of compartments 51, 53 and 55 of the cores-envelope 50, or of the cores-harness 250. The articulation is provided by the articulation creases 39 between the plurality of compartments 61, 63, 65 of the pillowcase 60.

The top surface 70 of the pillowcase 60 is sewn and hinges along elongated perimeter wall 68. As illustrated in FIG. 6B, the top surface 70 of the pillowcase 60 is held in the closed position by a plurality of mechanical closures 67 arranged around the upper edges of perimeter walls 62, 64 and 66. The mechanical closures may include, but are not limited to snaps, hooks, buttons, zippers, hook-and-loop fasteners or other mechanical fasteners known in the art.

The articulated design of the pillowcase 60 permits the quick and easy re-positioning of one or both outer modules, to convert the pillow 30 of the present invention from a back-sleeper pillow to a side-sleeper pillow, and vice-versa. The articulation occurs along creases 39 shown in FIG. 1A and FIGS. 6A-6B, which allow movement and rotation.

### Fixed-Geometry Pillows

Although the variable-geometry pillow discussed above is preferred, it is recognized that pillows and other cushion in accordance with the present invention may have a fixed geometry, provided it has a core formed from one or more monolithic blocks of a large-cell reticulated foam material and a cover that surrounds the core and is formed from a large open-weave material that has openings therethrough that are sized to allow air to flow freely by natural convection through the cover.

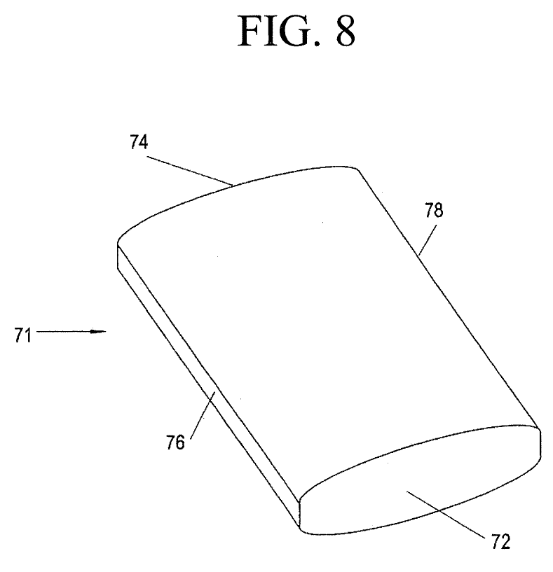

FIG. 8 shows one embodiment of a fixed-geometry pillow 71 in accordance with the present invention in which the core consists of a single block of reticulated foam formed in a shape of a traditional pillow. It is noted that the pillowcase has been omitted from FIG. 8 for purposes of clarity. The pillow 71 has a first end 72, a second opposing end 74, a third elongated side 76 and a fourth elongated opposing side 78. The thickness of the pillow 71 varies so that the thickest portion is toward the middle with thinner portions toward the edges 76 and 78. As discussed above, the large open-cell structure of the reticulated foam permits the free flow of air and of the heat it is carrying away unobstructed, through any of the faces of the pillow 71 delineated by its perimeter. Heat transfer through conduction, convection and thermal radiation is enhanced by the large open-cell structure.

The pillow of the present invention can be shaped to accommodate various types of sleepers by varying the thickness and firmness of the pillow. A soft pillow is ideal for stomach sleepers since the soft pillow allows the head of a user to be positioned at a natural, restful angle. A medium pillow is a good choice for back sleepers since the medium pillow rests the head and the neck at the most comfortable position. A firm pillow is a good choice for side sleepers since the firm pillow eases stress on the neck and the shoulders. A super firm pillow is the ideal choice for side sleepers since the super firm pillow provides the most amount of support for the user.

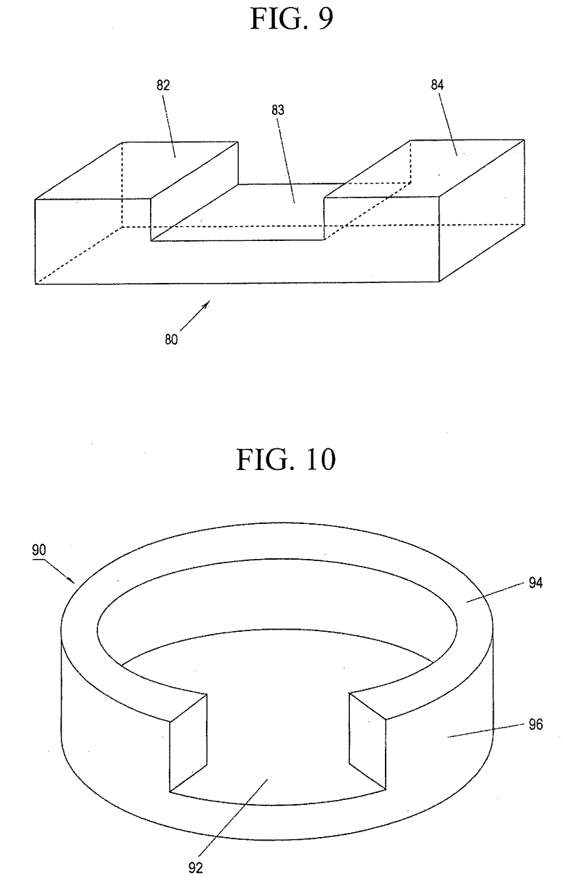

FIG. 9 illustrates an embodiment of the pillow 80 of the present invention where varying thicknesses accommodate different types of sleepers; i.e. the side-sleeper, the back-sleeper and the stomach-sleeper. In this embodiment, a first portion 82 and a second portion 84 are substantially thicker than a middle portion 83. The thicker first portion 82 and thicker second portion 84 provide the proper height to support the head of a side sleeper so that the spine may be properly aligned to reduce spinal pressure and increase sleeper comfort. The middle portion 83 would be used by a stomach sleeper or a back sleeper.

### Pet Bed

It is common to see pets, primarily dogs, looking for cool spots to lie on when it is hot, shunning their comfortably padded beds and finding comfort on the hard but cool kitchen floor tiles. The materials used in traditional pet beds lack ventilation and store heat that can cause discomfort of the pet.

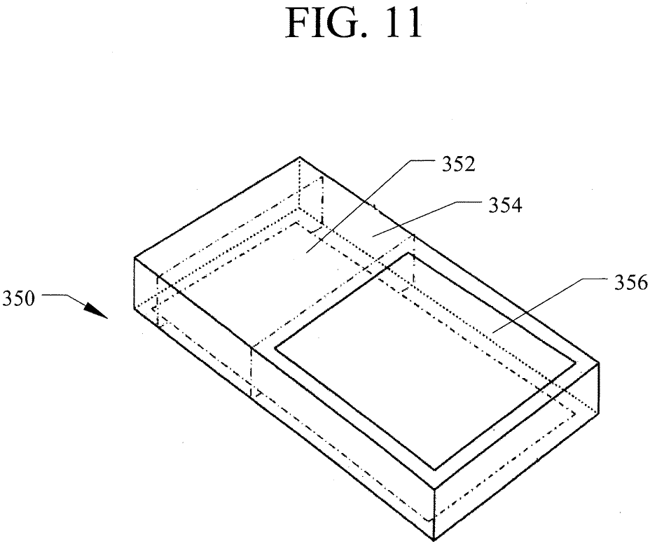

As shown in FIG. 10, the pet bed 90 of the present invention is based on the same principles and requirements of the pillow of the present invention and pillowcase of the present invention presented above. The pet bed 90 transfers heat according to the physics laws of heat and mass transfer as discussed above. The components of the pet bed 90 are permeable to the easy through-flow of air.

The pet bed 90 of the present invention includes a base portion 92 surrounded by a raised portion 94 inside a circumferential outer surface 96. The base portion 92 and the raised portion 94 are formed from a core of reticulated foam material with a large open-cell structure which allows the unobstructed passage of air to dissipate the heat generated by the pet, thus keeping the pet comfortable, especially in hot weather.

The pet bed 90 of the present invention can be of various shapes including, but not limited to, elliptical, circular, rectangular or square. Other shapes recognized by those skilled in the art are within the spirit and scope of the present invention.

When necessary, the pet bed 90 can be cleaned by soaking in a mild detergent solution then rinsed. Because of the large open-cell structure, the pet bed 90 will dry quickly.

A cover may be inserted over the reticulated foam core of the pet bed 90. This cover is made from the same breathable cover material discussed above with regard to the cores-envelope and pillowcase, which facilitates the through-flow of air and the dissipation of body-generated heat from the pet. The cover espouses the general shape of the pet bed. The cover is easily removable for washing.

### Infant Mattress

The present invention is also readily adapted for use as a mattress for infant bassinets in hospital nurseries and later in their bassinet or cribs at home. As noted above, this provides the distinct advantage of increasing airflow around the infant, which may reduce the likelihood of SIDS.

The hospital bassinet is basically a rectangular parallelepiped box. Its base is about thirty by twenty inches, its sides are about ten inches high, and it has no top. The infant, lying prone with his/her face and nose touching the bassinet sheet where the air movement is practically nil, could ultimately be breathing his/her own deadly carbon dioxide, and poison him/herself.

A mattress of the present invention, made of a large-cell reticulated foam material, placed at the bottom of the bassinet could alleviate this situation by stimulating air circulation. This air movement could be substantially increased by adding large openings in the bottom and sides of the bassinet, thus encouraging a natural convection motion of the air around the bassinet.

The basic embodiment of the infant mattress 350 is shown in FIG. 11. The infant mattress 350 preferably includes an inner core 352 made of a two-inch thick monolithic block of reticulated foam material dimensioned to fit within the bottom of the bassinet. However, the core 352 may take any shape necessary to conform to the crib or bassinet within which it is to be disposed. The cover 354 is a fitted sheet that surrounds the core 352 and is made of the same air-permeable breathable large-open-weave materials discussed herein with regard to the cores-envelope and pillowcase. The preferred cover includes a kangaroo pouch 356 disposed on the top surface of the cover proximate to the area where the infant's diaper will rest. A diaper is housed in the pouch 356 to prevent any leakage from the infant's diaper to reach the core 352. However, in some embodiments, this kangaroo pouch 356 is replaced by a rectangular sheet of absorbent material (not shown) that is removably attached to the top surface of the cover. In still other embodiments, both the kangaroo pouch 356 and rectangular sheet are omitted.

When necessary, the core 352 can be cleaned by soaking in a mild detergent solution then rinsed. Because of its large open-cell structure, the core 352 will dry quickly.

While this invention has been particularly shown and described with references to preferred embodiments thereof, it will be understood by those skilled in the art that various changes in form and details may be made therein without departing from the scope of the invention encompassed by the appended claims.

What is claimed is:

1. A self-ventilating and self-cooling cushion comprising:
at least one core comprising at least one monolithic block of a reticulated foam material having a porosity of between five pores per linear inch and twenty-five pores per linear inch; and
at least one cover surrounding said core, wherein said cover is formed from a material having a plurality of openings therethrough and wherein each of said plurality of openings is dimensioned to allow air to flow freely by natural convection through the cover.

2. The cushion as claimed in claim 1 wherein said cushion is a variable geometry pillow comprising:
a middle module comprising a top surface and a middle core;
a first outer module connected to said middle module, said first outer module comprising a top surface and a first outer core;
a second outer module connected to said middle module, said second outer module comprising a top surface and a second outer core; and
means for securing said first outer module and said second outer module to said middle module such that said first outer module and said second outer module are allowed to rotate with respect to the middle module such that said top surface of the first outer module and said top surface of said second outer module contacts said top surface of said middle module.

3. The cushion as claimed in claim 2 wherein said means for securing said outer modules to said middle module comprises a cores-envelope and wherein said cores-envelope is one of said at least one cover.

4. The cushion as claimed in claim 3 wherein said cores-envelope comprises;
a middle compartment dimensioned to surround said middle core, said middle compartment comprising open ends proximate to said first outer module and said second outer module;
a first outer compartment dimensioned to surround said first outer core, said first outer compartment comprising one open end proximate to said middle module; and
a second outer compartment dimensioned to surround said second outer core, said second outer compartment comprising one open end proximate to said middle module;
wherein said first outer compartment and said second outer compartment are rotatably attached to said middle compartment.

5. The cushion as claimed in claim 4 wherein said cores-envelope is formed from a single sheet of material and wherein said first outer compartment and said second outer compartment are rotatably attached to said middle compartment by articulation creases in said sheet of material.

6. The cushion as claimed in claim 4 wherein said at least one cover comprises two covers, wherein a first of said two covers is said cores-envelope and wherein a second of said two covers is a pillowcase.

7. The cushion as claimed in claim 6 wherein said pillowcase is dimensioned to accept said cores-envelope therein and comprises a middle compartment, a first outer compartment, a second outer compartment, and a top rotatably attached to said first outer compartment, said second outer compartment and said middle compartment.

8. The cushion as claimed in claim 2 wherein said means for securing said first outer module and said second outer module to said middle module comprises a cores-harness and wherein said at least one cover comprises a pillowcase dimensioned to allow said first outer module and said second outer module to rotate with respect to the middle module such that said top surface of said first outer module and said top surface of said second outer module contacts said top surface of said middle module.

9. The cushion as claimed in claim 8 wherein said cores-harness comprises two outer sets of straps, a middle set of straps, and a folding set of straps.

10. The cushion as claimed in claim 9 wherein a first of said two outer sets of straps is disposed about said first outer module, wherein a second of said two outer sets of straps is disposed about said second outer module, wherein said middle set of straps is disposed about said middle module, and wherein said folding set of straps is disposed about said first outer module, said middle module and said second outer module such that the said first outer module and said second outer module rotate with respect to the middle module such that said top surface of said first outer module and said top surface of said second outer module contact said top surface of said middle module.

11. The cushion as claimed in claim 8 wherein said pillowcase is dimensioned to accept said first outer module, said middle module and said second outer module and comprises a middle compartment, a first outer compartment, a second outer compartment, and a top rotatably attached to said first outer compartment, said second outer compartment and said middle compartment.

12. The cushion as claimed in claim 1 wherein said plurality of openings through said cover are disposed and dimensioned such that there are between about five and one hundred openings per square inch.

13. The cushion as claimed in claim 12 wherein said plurality of openings through said cover are disposed and dimensioned such that there are between about fifteen and fifty openings per square inch, and wherein said at least one block of a reticulated foam material has a porosity of between about five pores per linear inch and ten pores per linear inch.

14. The cushion as claimed in claim 1 wherein said cushion is a fixed geometry pillow;
wherein said at least one core comprises a single core having a first end, a second opposing end, a third elongated side, and a fourth elongated opposing side, defining a thickness, wherein said thickness increases from said third elongated side to a midpoint between said third elongated side and said fourth elongated side and decreases from said midpoint to said fourth elongated side; and
wherein said at least one cover comprises a pillowcase dimensioned to surround said single core.

15. The cushion as claimed in claim 1 wherein said cushion is a fixed geometry pillow;
wherein said at least one core comprises a single core having a first portion, a second portion and a middle portion disposed between said first portion and said second portion, said middle portion having a thickness that is less than a thickness of said first portion and said second portion; and
wherein said at least one cover comprises a pillowcase dimensioned to surround said single core.

16. The cushion as claimed in claim 1 wherein said cushion is a pet bed;
wherein said at least one core comprises a base portion and a raised portion extending from said base portion; and
wherein said cover is dimensioned to surround said base portion and said raised portion of said core.

17. The cushion as claimed in claim 1 wherein said cushion is an infant mattress;
wherein said at least one core comprises a single core dimensioned in a shape of a substantially rectangular prism having a top and a bottom defining a thickness, a right side and a left side defining a width, and a front side and a back side defining a length; and
wherein said cover is dimensioned to cover said top and at least a portion of said right side, said left side, said front side and said back side.

18. The cushion as claimed in claim 1 wherein said cover further comprises a kangaroo pouch.

19. The cushion as claimed in claim 1 wherein said at least one core comprises two cores and wherein said at least one monolithic block of a reticulated foam material comprises a first monolithic block of reticulated foam material and a second monolithic block of reticulated foam material; wherein said first monolithic block of reticulated foam material and said second monolithic block of reticulated foam material each has a different porosity.
